(19) United States
(12) Patent Application Publication
(10) Pub. No.: US 2017/0299017 A1
(43) Pub. Date: Oct. 19, 2017

(54) CROSS LINKED ELASTOMERIC FACING ON CAST POLYURETHANE SYNCHRONOUS DRIVE BELTS

(71) Applicant: ContiTech Antriebssysteme GmbH, Hannover (DE)

(72) Inventors: Michael John William Gregg, Lincoln, NE (US); Benjamin William Roberts, Lincoln, NE (US); Jeffrey Dwight Lofgren, Lincoln, NE (US)

(73) Assignee: ContiTech Antriebssysteme GmbH, Hannover (DE)

(21) Appl. No.: 15/132,262

(22) Filed: Apr. 19, 2016

(51) Int. Cl. F16G 1/04; F16G 1/08; F16G 1/28; F16G 5/20

(52) U.S. Cl. CPC F16G 1/04; F16G 5/20; F16G 1/08; F16G 1/28

(57) ABSTRACT

A fabric layer includes a fabric and a crosslinkable elastomer, where the fabric defines a first side and the crosslinkable elastomer defines an opposing side. The fabric is coated with a crosslinkable elastomer and the combination is molded into a multiple tooth shaped fabric layer. In some aspects, the first side is an inner surface void of the crosslinkable elastomer. In some cases, the crosslinkable elastomer is crosslinked while the fabric layer is molded, while in some other cases, the crosslinkable elastomer is surface cured while the fabric layer is molded. The crosslinkable elastomer may be an alloy of crosslinkable polyethylene and EPDM. The fabric layer may be used as an outer layer of a synchronous drive belt, a timing belt, a poly-v belt, or offset tooth belt.

### FIELD

The field to which the disclosure generally relates to woven fabric coverings for the teeth of synchronous drive belts, and to belts having a corresponding tooth layer.

### BACKGROUND

This section provides background information to facilitate a better understanding of the various aspects of the disclosure. It should be understood that the statements in this section of this document are to be read in this light, and not as admissions of prior art.

Synchronous drive belts are primarily used as power transmission belts. In this use, the teeth of the synchronous drive belts engage between the teeth of an opposite belt or of a toothed disc to effect power transmission. Synchronous drive belts are often used in synchronous or positive drives, for example to provide synchronization between two rotating shafts.

Synchronous drive belts are frequently standard rubber toothed belts having, in general, a rearward region, a toothed front region and an interposed tensile layer based on, for example, steel or glass cord. The toothed front region frequently includes a vulcanizate based on HNBR, that is, a hydrogenated acrylonitrile-butadiene rubber copolymer, which customarily includes fillers. The mechanical and thermal resistance demands on such belts increase with increases in the power levels of the machines in which they are used. Long durability and high mechanical resistance over a broad service temperature range are therefore indispensable.

To enhance the mechanical stability of toothed belt teeth, the surfaces of the teeth may be provided with a covering, which is generally continuous and completely covers the crests, flanks and roots of the teeth. This covering can include a coating of, for example, a modified vulcanizate, or it can preferably be formed from a knitted or woven fabric. In some application, woven polyamide 6,6 stretch fabric has proved very useful for this purpose in that it has good mechanical properties and good adhesion to the tooth rubber.

In high performance synchronous drive belts a facing fabric is typically formed by viscous elastomer during the cure process, or in the case of cast polyurethane belts the layer of fabric is covered in a layer of thermoplastic polyethylene which is preformed with a heat and cool molding process, and applied to the belt mold. The facing fabric covering the toothed side of the belt helps both reinforcing the tooth, and provides a low friction wear resistant surface to engage pulleys. In use, the thermoplastic polyethylene may be prone to cold flow during service away from the loaded areas. Cold flow is the tendency of a solid material to move slowly or deform permanently under the influence of mechanical stresses. It can occur as a result of long-term exposure to high levels of stress that are still below the yield strength of the material. Cold flow is more severe in materials that are subjected to heat for long periods, and generally increases as they near their melting point.

As drive systems, such as the motor vehicles, are being equipped with more and more powerful engines or motors, and engines or motors are more and more completely enclosed to reduce noise, synchronous drive belts are exposed to ever higher operating temperatures. Thus, there exists a need for fabric layer tooth coverings having superior and long-term high temperature resistance.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In a first aspect of the disclosure, a fabric layer includes a fabric and a crosslinkable elastomer, where the fabric defines a first side and the crosslinkable elastomer defines an opposing side. The fabric is coated with a crosslinkable elastomer and the combination is molded into a multiple tooth shaped fabric layer. In some aspects, the first side is an inner surface void of the crosslinkable elastomer. In some cases, the crosslinkable elastomer is crosslinked while the fabric layer is molded, while in some other cases, the crosslinkable elastomer is surface cured while the fabric layer is molded. In some embodiments, the crosslinkable elastomer may be an alloy of crosslinkable polyethylene and EPDM. The fabric layer may be used as an outer drive surface layer of a synchronous drive belt, a timing belt, a poly-v belt, or offset tooth belt.

In another aspect of the disclosure, a synchronous drive belt includes a drive surface that includes trapezoidal or curvilinear teeth, a compression section, a tension section, a load carrying section disposed between the compression section and the tension section, and a fabric adhered to the outer drive surface of the belt. The fabric layer includes a fabric and crosslinked elastomer coating disposed on an outer surface of the fabric layer. In some cases, an insulation layer is disposed between the compression section and the fabric layer. In some aspects, the load carrying section includes load carrying filaments or cords, which are embedded in an elastomeric/thermoplastic material. In some embodiments, the synchronous drive belt compression section is formed of an elastomeric/thermoplastic material. In some aspects, the elastomeric/thermoplastic material is a polyurethane material.

The fabric forming the fabric layer may be untreated on the side facing the compression section. In other cases, the fabric is treated with an adhesive system compatible with elastomeric/thermoplastic materials used in the compression section. The fabric may be one or more of a high tenacity nylon, a polyaramid or a polyester, and in some aspects, the crosslinked elastomer is an alloy of crosslinkable polyethylene and EPDM.

In another aspect of the disclosure, a belt includes an outer surface, a tension section, a compression section disposed between the outer surface and the tension section, and a fabric layer adhered to the outer surface of the belt. The fabric layer has a fabric, and crosslinked elastomer coating disposed on an outer surface of the fabric. The compression section may be an elastomeric/thermoplastic material, which in some embodiments is a polyurethane material. In some embodiments, a load carrying section is disposed between the compression section and the tension section, and may include load carrying filaments or cords, which are embedded in an elastomeric/thermoplastic material.

In some aspects, the fabric of the fabric layer is coated, on the side facing the compression section, with an adhesive system compatible with the elastomeric/thermoplastic material of the compression section. In some other aspects, the fabric is untreated on the side facing the compression section.

Yet another aspect of the disclosure are methods include providing a fabric and a crosslinkable elastomer comprising polyethylene and EPDM, coating the fabric with the crosslinkable elastomer, placing the fabric coated with the crosslinkable elastomer into a mold, and molding the fabric and crosslinkable elastomer into a multiple tooth shaped fabric layer. Some methods may further include placing the fabric layer in a belt mold over a tension member, injecting an elastomeric/thermoplastic material into the belt mold, and curing the crosslinkable elastomer to form a tooth shaped belt with a crosslinked fabric layer. In some cases, the fabric of the fabric layer faces the elastomeric/thermoplastic material and the crosslinkable elastomer of the fabric layer defines an outer surface of the tooth shaped belt.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIGS. 1A through 1C show elements of a fabric layer having a fabric and crosslinkable elastomer, in accordance with an aspect of the disclosure, in a perspective view;

FIGS. 2A and 2B illustrate molding fabric layer into a tooth shaped fabric layer using a mold, in accordance with an aspect of the disclosure, in a cross-sectional view;

FIG. 3 illustrates a synchronous drive belt in accordance with an aspect of the disclosure, in a perspective view;

FIG. 4 depicts a poly-v belt in accordance with some aspects of the disclosure, in a perspective view;

FIG. 5 illustrates a timing belt according to an aspect of the disclosure, in a perspective view; and,

FIG. 6 shows another synchronous drive belt in accordance with an aspect of the disclosure, in a perspective view.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. While the materials used in the present disclosure are described herein as comprising certain components, it should be understood that the materials could optionally comprise two or more chemically different materials. In addition, the materials can also comprise some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value, concentration and/or amount range listed or described as being useful, suitable, or the like, is intended that any and every point within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some embodiments of the disclosure are power transmission belts, which contain compounds and materials providing the belts with improved properties in regards to belt growth, wicking, abrasion, cold flow resistance, and durability. Such belts have a compression section, a tension section, a load carrying section disposed between the compression section and the tension section, and at least one drive surface. The belts have an elastomeric/thermoplastic material. The drive surface has a fabric layer bonded to the outer surface of the belt, and the surface is crosslinked or cured, which provides resistance to cold flow. The fabric may function as a tie layer between the cast elastomeric/thermoplastic material and the surface layer, which are normally incompatible.

The fabric used in embodiments according to the disclosure may be of any suitable design, construction and material, and is utilized and intimately configured along the alternating teeth and land portions of the belt to form a portion of the fabric layer therefor. This fabric may be a nonwoven fabric, or woven fabric, consisting of warp and weft threads laid at any desired angle. In some aspects, the fabric may consist of warp threads held together by spaced pick cords, or of a knitted or braided configuration, and the like. In some embodiments, more than one ply of fabric may be employed. If desired, the fabric may be cut on a bias so that the strands form an angle with the longitudinal direction of travel of a belt in which it is incorporated. The angle may be of any suitable angle, for example, but not limited to, from about 30 degrees to about 60 degrees, or any point along the continuum between.

In some aspects of the disclosure, the fabric used in the fabric layer may be high tenacity nylon, aramid, polyester or any other suitable synthetic fiber. The fabric is coated on one side with an alloy of crosslinkable polyethylene and EPDM, or any other suitable crosslinkable elastomer with low friction coefficient to metal and high abrasion resistance, to form a layer, which may also be referred to as a ‘fabric layer’. The opposing side is left untreated in some cases, or treated with an adhesive system compatible with polyurethane, which may be cast in a belt. In some aspects of the disclosure, conventional materials including nylon (such as nylon 4, 6, nylon 6, 6 and nylon 6), cotton, polyester, cotton/polyester, nylon/polyester, cotton/nylon, Lycra™ (segmented polyurethane), aramid, rayon and the like, as well as blends thereof, are used as threads of the fabric. In some other aspects, a blend fabric is used based on polyamide wherein at least a substantial portion of the threads in the fabric comprise at least one member of the group consisting of polyether ether ketone (PEEK), polyimide (PI), meta-aramid (M-A), or any combination thereof.

This fabric layer may be preformed into a tooth shape in a mold, and thereafter heat is applied to crosslink or cure the surface. This perform may, in some cases, be applied to a belt mold covered with the tension member and the elastomeric/thermoplastic material(s) poured or injected into the mold and allowed to cure. In some aspects, the elastomeric and/or thermoplastic materials are polyurethane based materials.

In some aspects, the elastomeric/thermoplastic material used in a belt body contains from about 50 to about 90 parts per hundred of an elastomer, and from about 10 to 50 about parts per hundred thermoplastic. Alternatively, the elastomeric/thermoplastic material may be formed from about 60 to about 80 parts per hundred elastomer and from about 20 to about 40 parts per hundred thermoplastic. In one aspect of the disclosure, the elastomer of the elastomeric/thermoplastic material is selected from the group consisting of natural rubber, polychloroprene, acrylonitrile-butadiene copolymers, polyisoprene, zinc salts of unsaturated carboxylic acid ester grafted hydrogenated nitrile butadiene elastomers, styrene-butadiene rubbers, polybutadiene, polyurethane, ethylene propylene diene monomer rubber, hydrogenated acrylonitrile-butadiene copolymers, polyurethane, and ethylene-acrylic elastomers. In another aspect, the elastomer of the elastomeric/thermoplastic material is a polyurethane material. The thermoplastic component may be: polyolefin thermoplastic resins, such as high density polyethylene (HDPE), ultrahigh molecular weight polyethylene (UHMWPE), polypropylene (PP), and ethylene propylene copolymer thermoplastic resin; polyamide thermoplastic resins, such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MxD6), nylon 6T, nylon 6/6T copolymer, nylon 66/PP copolymer, and nylon 66/PPS copolymer; or vinyl resins, such as vinyl acetate (EVA), polyvinylalcohol (PVA), vinyl alcohol/ethylene copolymer (EVOH), polyvinylidene chloride (PVDC), polyvinyl chloride (PVC), vinyl chloride/vinylidene chloride copolymer, polyurethane resins and vinylidene chloride/methylacrylate copolymer.

Alternatively, the thermoplastic of the elastomeric/thermoplastic material may be a polyurethane resin. In another aspect, the elastomeric/thermoplastic material forms an insulation layer in the belt, the insulation layer being located in the compression section of the belt.

In addition to the elastomer and thermoplastic components, the compound may also contains curing agents. Curing agents which may be employed in the compositions of the invention include, for example, di-tertbutyl peroxide, dicumyl peroxide, benzoyl peroxide, 2,4-dichlorobenzol peroxide, t-butyl-cumyl peroxide, t-butyl perbenzoate, t-butyl peroxide, t-butylperoxy(2-ethyl hexanoate), 2,5-dimethyl-2,5-di(benzoylperoxy)-hexane, benzoyl peroxide, 2,5-dimethyl-2,5-(t-butyl peroxy)-hexane, 1,1-ditert-butyl peroxy-3,3,5-trimethyl cyclohexane, 4,4-ditert-butyl peroxy n-butyl valerate and n-butyl-4,4-bis(t-butyl peroxy) valerate. Additional curing agents which may be employed include diacyl or dialkyl peroxides such as α,α′-bis(t-butylperoxy)-isopropylbenzene, 2,5-dimethyl-2,5-di(t-butylperoxy) hexane, di-t-butyl peroxide, 2,5-dimethyl-2,5-di-(t-butylperoxy)hexyne-3, lauroyl peroxide, t-butyl hydroperoxide, t-amyl hydroperoxide, cumene hydroperoxide, t-butyl perbenzoate, t-butyl peroxide, t-butylperoxy(2-ethyl hexanoate), 2,5-dimethyl-2,5-di (benzoylperoxy)-hexane and benzoyl peroxide. All of the above curing agents are commercially available. The amount of curing agent may vary, and will generally range from 0.1 to 10 phr.

The compound may also contain a reinforcement material such as carbon black. The amount of carbon black will vary from about 15 to about 75 phr rubber. A portion of the carbon black may be specifically treated to be electro-conductive to reduce static build up in the belt.

In another aspect, the load carrying section of a belt has reinforcing cords therein. The cords are embedded in a material, the embedding material being the elastomeric/thermoplastic material.

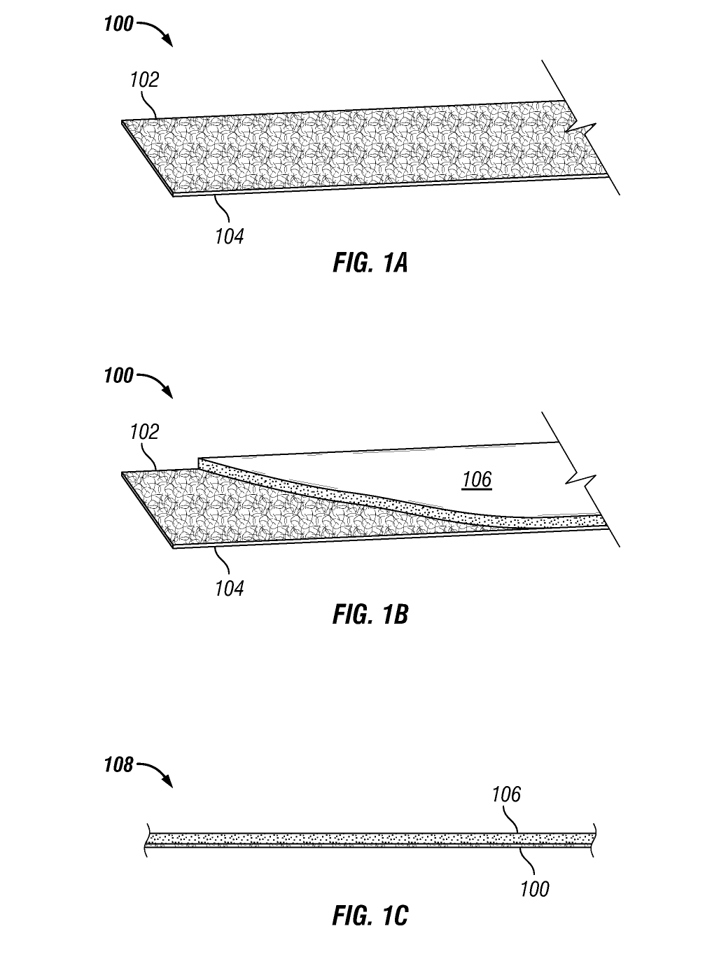

Now referencing FIGS. 1A through 10, which together illustrate some elements of a fabric layer having a fabric and crosslinkable elastomer, according to some embodiments of the disclosure. FIG. 1A shows the fabric 100 which defines a first side 102, and the crosslinkable elastomer defines an opposing second side 104. As depicted in FIG. 1B, first side 102 is coated with a suitable crosslinkable elastomer 106, partially shown. The second side, may remain untreated in some cases, or treated with an adhesive system compatible with other materials useful in an overall belt design. As shown in FIG. 10 in a cross-sectional view, a fabric layer 108 is provided which includes fabric 100 on one side, and crosslinkable elastomer 106 defining an opposing side.

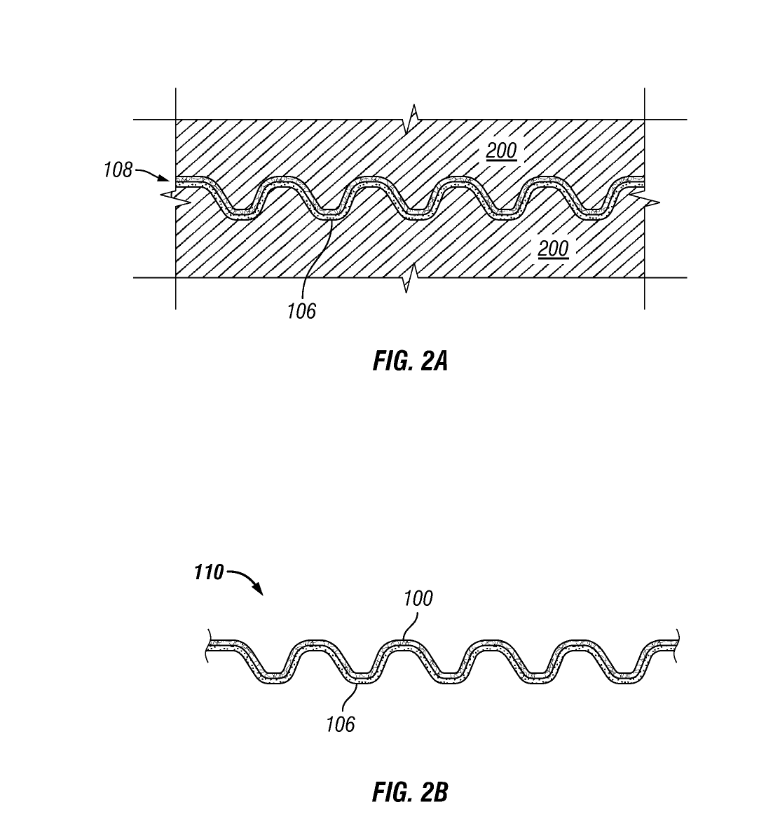

FIG. 2A illustrates in a cross-sectional view, molding fabric layer 108 into a tooth shaped fabric layer in a mold 200. While resident in mold 200, heat may be applied to crosslink, or cure the surface of, crosslinkable elastomer 106. The resultant structure is a tooth shaped fabric layer 110, as depicted in FIG. 2B in cross-sectional view, having fabric 100 and surfaced cured or crosslinked elastomer 106. In some embodiments, tooth shaped fabric layer 110 is then applied to a belt mold covered with a tension member and liquid polyurethane poured or injected into the mold and allowed to cure.

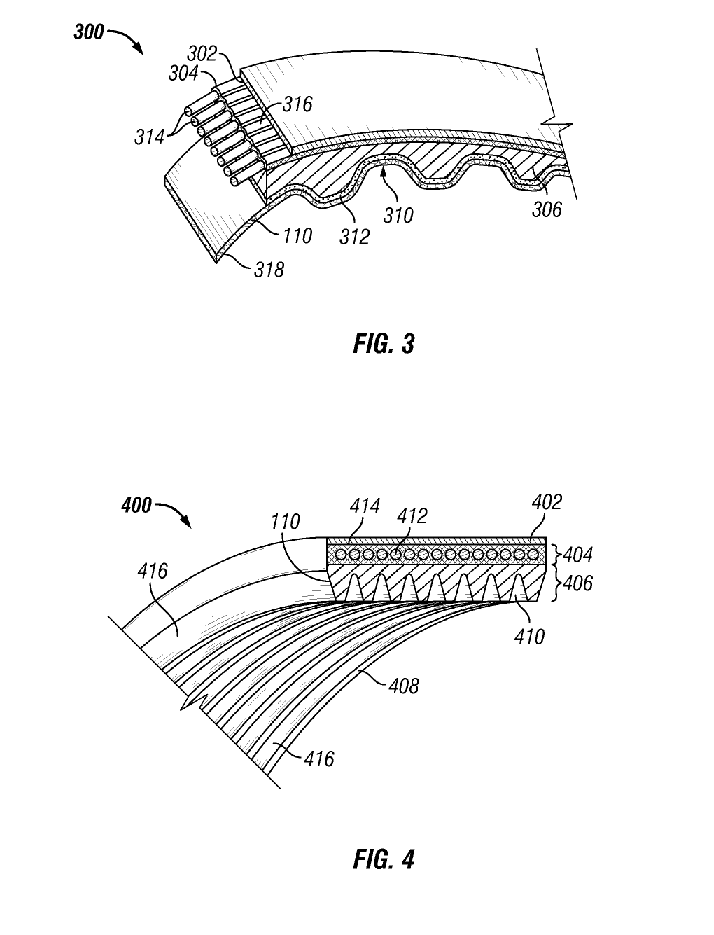

FIG. 3 illustrates an endless power transmission belt 100 according to an aspect of the disclosure. The belt 300 is particularly adapted to be used in associated sheaves in accordance with techniques known in the art. The belt is particularly suited for use in synchronous drive applications. The belt 300 may be adapted to be used in so-called torque sensing drives, application where shock loads of varying belt tension are imposed on the belt, applications where the belt is operated at variable speeds, applications where the belt is spring-loaded to control its tension and the like.

The belt 300 includes a tension section or backing 302, a cushion, or compression section 306, a load-carrying section 304 disposed between the tension section 302 and cushion section 306, and a preformed toothed fabric layer 110 (such as those described above) adhered to drive surface 310. The belt may optionally have an insulation layer 312 located between the cushion section 306 and the fabric layer 110 to prevent or decrease rubber from the cushion section 306 from permeating through the fabric layer 110 to the drive surface 310. The fabric layer 110 is coated on the drive surface 310 side with a suitable crosslinkable elastomer. The other side, facing the compression section 306 is either left untreated in some cases, or treated with an adhesive system compatible with the elastomeric/thermoplastic material forming the compression section 306. The cured fabric layer 110 forms a facing fabric layer 318.

In some belts of the present disclosure, there is at least one drive surface 310 having a fabric layer 110 bonded to the outer surface. In the embodiment shown in FIG. 3, there is one drive surface 310 having a fabric layer 110. In accordance with other embodiments, the belt 300 may have multiple drive surfaces of two or more. A fabric layer 110 may also be on the non-drive outer surface of the belt.

The load-carrying section 304 has load-carrying means in the form of load-carrying filament or cords 314 embedded in a compound 316. The cords may be transverse or parallel to the length of the belt. The cords 314 or filaments may be made of any suitable material, examples of such materials include aramid, fiberglass, nylon, polyester, cotton, steel, carbon fiber and polybenzoxazole.

The drive surface 310 of the belt 300 of FIG. 1 is synchronous. In accordance with other embodiments, the belts of the present invention also include those belts where the drive surface of the belt may be smooth, single V-grooved, and multi-V-grooved. Representative examples of synchronous include belts having trapezoidal or curvilinear teeth.

The elastomers for use in the tension section 302 and the compression section 106 may be the same or different. Conventional elastomers which may be used in one or both of these sections include natural rubber, polychloroprene, acrylonitrile-butadiene copolymers (NBR), polyisoprene, zinc salts of unsaturated carboxylic acid ester grafted hydrogenated nitrile butadiene elastomers, styrene-butadiene rubbers, polybutadiene, ethylene propylene diene monomer rubber (EPDM), hydrogenated acrylonitrile-butadiene copolymers (HNBR), polyurethane, and ethylene-acrylic elastomers.

When incorporated, the insulation layer 312 is a blend of an elastomer and a thermoplastic. The material forming the insulating layer may have from about 50 to about 90 parts per hundred (pph) elastomer and from about 10 to about-50 pph thermoplastic, with preferred amounts of from about 60 to about 80 pph elastomer and from about 20 to about 40 pph thermoplastic. Herein, the term elastomer identifies thermosetting high polymers that solidify or set irreversibly when heated, usually due to a cross-linking reaction induced by heat or radiation of the material. Most elastomers have the ability to stretch and retract rapidly to approximately their original length when released. Herein, the term thermoplastic identifies a class of high polymers that soften when exposed to heat and returns to its original condition when cooled to room temperature. The elastomer component of the insulation layer 312 may be selected from conventional elastomers used in manufacturing belts and includes, but is not limited to, the list of elastomers set forth above in the discussion of elastomers for use in the tension section 302 and compression section 306 of the belt 300.

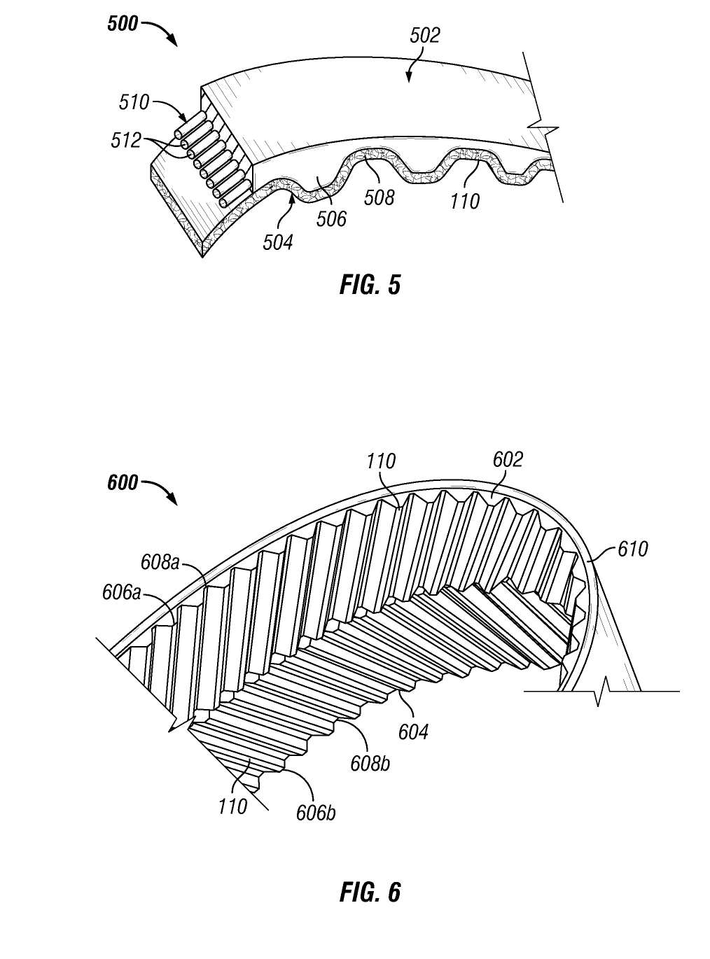

FIG. 4 illustrates a poly-v belt 400, in accordance with another embodiment of the disclosure. The belt 400 has a tension section 402, a load carrying section 404, and compression section 406. The compression section 406 has a plurality of longitudinal ribs 408 with a plurality of longitudinal grooves 410. The load carrying section 404 has longitudinal reinforcing cords 412 embedded in a suitable material 414. The elastomeric/thermoplastic materials disclosed above may be used as the material 414 in which the reinforcing cords 412 are embedded. Alternatively, the compression section may be provided with an additional layer formed of the elastomeric/thermoplastic material, a fabric layer 110, similar to those described above, is adhered to outer surfaces of the plurality of longitudinal ribs 408 and plurality of longitudinal grooves 410. The cured fabric layer forms a facing fabric layer 416.

With reference to FIG. 5, another belt embodiment, 500, such as a timing belt, is illustrated. Belt 500 includes elastomeric main body portion 502, which may be like or similar to a compression section, and an outer surface, which is a sheave contact portion 504 positioned along the inner periphery of main body portion 502. This particular sheave contact portion 504 is in the form of alternating transverse teeth 506 and land portions 508 which are designed to mesh with a transverse-grooved pulley or sprocket. Tensile reinforcement layer 510 is positioned within main body portion 502 for providing support and strength to belt 500. In the illustrated form, tensile reinforcement layer 510 is in the form of a plurality of tensile cords 512 aligned longitudinally along the length of main body portion 502. The tensile reinforcement layer 510, and cords 512 of belt 500 may be constructed from the same materials as described above.

A preformed toothed fabric layer 110 may be utilized fittingly along the alternating teeth 506 and alternating land portions 508 of belt 500 to form a fabric face cover or tooth cover for the sheave contact portion. The fabric in fabric layer 110 may be of any desired configuration such as a conventional weave consisting of warp and weft threads at any desired angle or may consist of warp threads held together by space pick cords, or of a knitted or braided configuration, or a nonwoven fabric, and the like. More than one ply of fabric may be employed, or combinations of different fabric types. If desired, fabric forming the fabric layer 110 may be cut on a bias so that the strands form an angle with the direction of travel of the belt. Fabric material for forming the fabric layer may be any suitable material, including those materials disclosed above. In an embodiment of the disclosure, fabric layer 110 consists of an expansible wear-resistant fabric in which at least one of the warp or weft threads is made of nylon. In some cases, the fabric is made from a nylon 66 stretch fabric. The fabric forming the fabric layer 110 is adhered to outer surfaces 506 and 508 and is coated on the outer side with a suitable crosslinkable elastomer. The opposing side, facing the main body portion 502 is either left untreated in some cases, or treated with an adhesive system compatible with the elastomeric/thermoplastic material forming the main body portion 502.

Yet another aspect of the disclosure includes use of fabric layers, such as 110 described above, in so called offset tooth belts. FIG. 6 depicts in a perspective view, a portion of an example of such an offset tooth belt. Belt 600 includes elastomeric main body portion 602, which may be like or similar to a compression section, and an outer surface, which is a sheave contact portion 604 positioned along the inner periphery of main body portion 602. This sheave contact portion 604 is in the form of offset rows of alternating transverse teeth 606a, 606b, and land portions 608a, 606b, which are designed to mesh with a transverse-grooved pulley or sprocket (not shown) having like offset rows of teeth and landing portions. Tensile reinforcement layer 610 is positioned within main body portion 602. In the illustrated form, tensile reinforcement layer 610 is in the form of a plurality of tensile cords 612 aligned longitudinally along the length of main body portion 602. The tensile reinforcement layer 610 may be constructed from the same materials as described above. A preformed toothed fabric layer 110, or pair of layers, may be utilized fittingly along the alternating teeth 606a, 606b and alternating land portions 608a, 608b to form a fabric face cover or tooth cover for the sheave contact portion.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A fabric layer comprising a fabric and a crosslinkable elastomer, wherein the fabric defines a first side and the crosslinkable elastomer defines an opposing side, and wherein the fabric and crosslinkable elastomer are molded into a multiple tooth shaped fabric layer.

2. The fabric layer according to claim 1 wherein the first side is an inner surface void of the crosslinkable elastomer.

3. The fabric layer according to claim 1 wherein the crosslinkable elastomer is crosslinked while the fabric layer is molded.

4. The fabric layer according to claim 1 wherein the crosslinkable elastomer is surface cured while the fabric layer is molded.

5. The fabric layer according to claim 1 wherein the crosslinkable elastomer comprises an alloy of crosslinkable polyethylene and EPDM.

6. The fabric layer according to claim 1 as used in a synchronous drive belt, a timing belt, a poly-v belt, or offset tooth belt.

7. A synchronous drive belt comprising a drive surface that includes trapezoidal or curvilinear teeth, a compression section, a tension section, a load carrying section disposed between the compression section and the tension section, and a fabric layer according to claim 1 adhered to the outer drive surface of the belt, wherein the first side faces the compression section.

8. The synchronous drive belt according to claim 7 further comprising an insulation layer disposed between the compression section and the fabric layer.

9. The synchronous drive belt according to claim 7, wherein the load carrying section includes load carrying filaments or cords which are embedded in an elastomeric/thermoplastic material.

10. The synchronous drive belt according to claim 7, wherein the fabric layer is untreated on the first side facing the compression section.

11. The synchronous drive belt according to claim 7, wherein the compression section comprises an elastomeric/thermoplastic material.

12. The synchronous drive belt according to claim 10, wherein the fabric layer is treated, on the first side facing the compression section, with an adhesive system compatible with the elastomeric/thermoplastic material.

13. The synchronous drive belt according to claim 7, wherein the elastomeric/thermoplastic material comprises a polyurethane material.

14. The fabric layer according to claim 1, wherein the fabric is a high tenacity nylon, a polyaramid or a polyester.

15. A belt comprising an outer surface, a tension section, a compression section disposed between the outer surface and the tension section, and a fabric layer adhered to the outer surface of the belt, wherein the fabric layer comprises a fabric and a crosslinkable elastomer, wherein the fabric defines a first side facing the compression section and the crosslinkable elastomer defines an opposing side of the fabric layer, and wherein the fabric layer is molded to the shape of a tooth.

16. The belt according to claim 15 further comprising a load carrying section disposed between the compression section and the tension section, and wherein the load carrying section includes load carrying filaments or cords which are embedded in an elastomeric/thermoplastic material.

17. The belt according to claim 15, wherein the elastomeric/thermoplastic material comprises a polyurethane material.

18. The belt according to claim 15 further comprising an insulation layer disposed between the compression section and the fabric layer.

19. The belt according to claim 15 which is one of a poly-v belt, timing belt, synchronous drive belt, or offset tooth belt.

20. A method comprising:
providing a fabric and a crosslinkable elastomer comprising polyethylene and EPDM;
coating the fabric with the crosslinkable elastomer;
placing the fabric coated with the crosslinkable elastomer into a mold; and,
molding the fabric and crosslinkable elastomer into a multiple tooth shaped fabric layer.

21. The method of claim 20 further comprising
placing the fabric layer in a belt mold over a tension member;
injecting an elastomeric/thermoplastic material into the belt mold; and,
curing the crosslinkable elastomer to form a tooth shaped belt with a crosslinked fabric layer;
wherein the fabric of the fabric layer faces the elastomeric/thermoplastic material and the crosslinkable elastomer defines an outer surface of the tooth shaped belt.

22. The method of claim 20, wherein heat is applied to the mold to cure the crosslinkable elastomer.

23. The method of claim 21, wherein the elastomeric/thermoplastic material comprises a polyurethane material.

24. The method of claim 23, wherein the fabric is treated with an adhesive system compatible with the polyurethane material.
